(19) United States
(12) Patent Application Publication
(10) Pub. No.: US 2023/0158457 A1
(43) Pub. Date: May 25, 2023

(54) METHODS AND SYSTEMS FOR THE SEPARATION OF METAL IONS FROM AN AQUEOUS FEED

(71) Applicant: NEXT-ChemX Corporation, Austin, TX (US)

(72) Inventor: Nikolai M. Kocherginsky, Urbana, IL (US)

(21) Appl. No.: 17/993,289

(22) Filed: Nov. 23, 2022

Related U.S. Application Data
(60) Provisional application No. 63/283,105, filed on Nov. 24, 2021.

(51) Int. Cl. B01D 61/38; B01D 61/24; B01D 63/04; C02F 1/26; C02F 1/44; B01D 69/02

(52) U.S. Cl. CPC B01D 61/38; B01D 61/243; B01D 63/043; C02F 1/26; C02F 1/44; B01D 69/02; B01D 2325/36; C02F 2101/10

(57) ABSTRACT

Methods and systems for the extraction of metals from an aqueous feed solution containing the metal ions. The aqueous feed solution is contacted with one side of a hydrophilic membrane support while an organic liquid is contacted with an opposite side of the hydrophilic membrane support. Metal ions migrate from the aqueous feed solution through the membrane support and into the organic liquid. The metal ions may be re-extracted from the organic liquid using a strip solution. The steps of extraction and reextraction may be carried out in a system including two hollow fiber membrane modules that each include a plurality of hydrophilic polymer hollow fibers.

### CROSS-REFERENCE TO RELATED APPLICATIONS

This application claims the priority benefit of U.S. Provisional Application No. 63/283,105 by Kocherginsky and filed on Nov. 24, 2021, which is incorporated herein by reference in its entirety.

### FIELD

This disclosure relates to the field of separation of metal ions from an aqueous feed using a liquid supported membrane.

### BACKGROUND

The separation, concentration and/or recovery of metal ions from aqueous solutions plays a very important role in chemical industry. Classical methods to achieve this include the use of ion exchange resin columns and separation using liquid/liquid extraction columns. Metal ion sorption onto an ion exchange resin or solvent extraction onto an organic extractant is typically followed by acid washing (e.g., stripping) to recover the metal ions. Both methods require large industrial equipment and include at least two distinct and independent steps, e.g., the extraction of the metal ions into a resin or into an organic liquid followed by the reextraction of the metal ions into a receiving aqueous solution. Both steps are typically carried out as batch multistage processes and require a significant amount of acid and water to recover and concentrate the metal product. The efficiency of the processes is predominately a function of the first step, and it is determined by its equilibrium constant. In the presence of excess acid, the overall efficiency is not significantly influenced by the second step of reextraction.

One technique to increase the efficiency of the extraction and reextraction steps is to utilize a supported liquid membrane (“SLM”). See, for example, U.S. Pat. No. 4,851,124 by Vandegrift et al., which discloses the immobilization of a water immiscible organic liquid within the pores of a thin support to form a SLM, e.g., where the organic liquid, immobilized and stabilized in the porous support, acts as a membrane. The SLM separates two aqueous solutions, one being a wastewater feed contaminated with a toxic compound and the other being a strong acidic solution. The contaminant permeates through the SLM from the wastewater to the acidic solution where the contaminant is converted to a non-toxic species.

To ensure that the organic liquid in the pores is not pulled out by the hydrodynamic pressure across the membrane, the membrane must satisfy at least two criteria: (i) the membrane must be hydrophobic; (ii) the pore radius (r) must be small enough so that the organic liquid in the membrane pores is not washed out or even pulled out by hydrodynamic pressure (P), which happens if P>>2σ/r, where a is the organic/water surface tension.

To utilize a SLM for the separation of non-oil soluble metal ions, it is necessary to transport the metal ions from an aqueous feed on one side of the SLM through the organic liquid supported in the pores of the SLM to the aqueous solution on the opposite side of the SLM. This can be achieved by dissolving a carrier within the organic liquid, where the carrier has a high affinity for the metal ion, e.g., a chelating agent or similar extractant. Metals are practically insoluble in an organic liquid, but the metal ions from the aqueous feed can form a species with a mobile carrier, which diffuses and carries the metal from the feed solution side of the membrane to the strip solution side of the membrane. The metal ions are subjected to a reversible chemical reaction (e.g., complexation) with a carrier dissolved in the organic liquid, and after this extraction the carrier facilitates the transfer of the metal ions through the supported organic liquid.

In one configuration, the aqueous feed is an alkaline (basic) solution, and the strip solution is acidic. As a result, two ion-exchange processes occur, one on each surface of the SLM. At the aqueous feed-membrane interface, the carrier reacts with the metal ion to form a metal species. The metal species diffuses through the SLM to the membrane-strip solution interface where the species reacts with an H⁺ ion, releasing the metal ion into the strip solution, while H⁺ from the strip solution binds to the carrier. The carrier is thereby regenerated and driven by its concentration gradient, it diffuses back to the feed-membrane interface where the process repeats. This process is known as facilitated coupled counter transport, e.g., Mⁿ⁺/H⁺ counter transport facilitated by the carrier.

Notably, the facilitated coupled counter transport process does not require any substantial transmembrane pressure or voltage. Even when the carrier is already saturated by the metal ions on the aqueous feed side of the SLM, the process does not stop since the metal ions are continuously removed to the acidic strip solution, which is a significant advantage in comparison to both ion exchange and extraction columns. Final equilibrium for monovalent cations (Me⁺) is not determined by the affinity of the metal ion to the resin or extractant, and is described by:

$$\frac{M {e}_{a c i d}^{+}}{M {e}_{alkali}^{+}} = \frac{{H}_{a c i d}^{+}}{{H}_{alkali}^{+}}$$

If the concentration of Hₐₗₖₐₗᵢ⁺ in the aqueous feed is less than concentration of H_{acid}⁺ in the strip solution, this will cause the metal ion to diffuse across the SLM even towards higher metal concentration. The metal ions can be accumulated from a large volume of the aqueous dilute feed into a small volume of the strip solution, where metal concentration may be reach saturation, leading to precipitation of a metal salt. The driving factor for this active ion transport is the pH difference between the two solutions, which shifts the equilibrium of the ion exchange.

An efficient implementation of this SLM-based process is to use hollow fiber membrane contactors as the membrane support. These devices consist of a membrane module that may include thousands of hollow fibers. Merely by way of example, one typical hollow fiber membrane contactor module may include microporous hydrophobic polypropylene hollow fibers with an internal diameter of about 400 μm, a wall thickness of about 25 μm, a void porosity of about 40% and an average pore diameter of about 0.03 pm. Hollow fiber membrane contactors offer up to 500 times more surface area per unit volume than traditional liquid/liquid extraction columns. When the hollow fiber walls are impregnated with an organic liquid, each fiber serves as a SLM. The aqueous feed solution flows on one side (e.g., within the lumen of the hollow fibers) and the strip solution flows outside of the hollow fibers, e.g., on the shell side. Rare earth metal recovery utilizing a SLM is disclosed in U.S. Pat. No. 9,968,887 by Bhave et al.

FIGS. 1A and 1B schematically illustrate the use of a SLM to separate metal ions from an aqueous feed according to the prior art. The SLM is in the form of a hollow fiber membrane support 110a having a sidewall 116a defining a lumen 112a through the membrane support 110a. In this prior art process, an aqueous feed 150 containing metal ions (Mⁿ⁺) is passed through the lumen 112a while an acidic strip solution 152 containing a high concentration of protons (H⁺) is passed through the shell side volume 114, e.g., outside of the hollow fiber support 110a.

The hollow fiber membrane support 110a is hydrophobic, enabling an organic liquid 154 to be supported within the pores of the support, e.g., within pore 118, and preventing the aqueous feed 150 and the acidic strip solution from permeating the membrane support 116a. The organic liquid 154 contains an extractant A⁻ (FIG. 1B) that is capable of binding Mⁿ⁺ to form metal species AₙM on one side of the membrane and as a result of ion exchange it is capable of forming a protonated species AH on another side of the membrane. Metal species AₙM forms at the aqueous feed-solution interface and, driven by its concentration gradient across the organic liquid 154, it diffuses through the organic liquid 154 to the strip solution 152. At the strip solution-membrane interface, the carrier A⁻ is regenerated as AH and diffuses from the strip solution 152 to the feed solution 150, i.e., counter-current to the diffusion of metal species ARM.

After the metal ion Mⁿ⁺ accumulates and concentrates in the strip solution 152, it can be recovered from the strip solution using known techniques. For example, coupled facilitated transport may move a divalent alkaline earth metal ion (e.g., Sr⁺²) through the SLM in exchange with two H⁺ ions. Typically, the aqueous feed will have a higher pH (e.g., more alkaline pH) than the strip solution. Final equilibrium is described by:

$$\frac{M {e}_{acid}^{2 +}}{M {e}_{alkali}^{2 +}} = {( \frac{{H}_{acid}^{+}}{{H}_{alkali}^{+}} )}^{2}$$

If the final concentrations are Hₐₗₖₐₗᵢ⁺=10⁻¹⁴M and H_{acid}⁺=1M , theoretically in an ideal situation, it is possible to reach a metal concentration ratio as high as 10²⁸, which is especially important for purification of radioactive wastewater. See Singapore Patent No. 70059 by Kocherginsky et al.

One method for metal recovery from spent ammoniacal etching solutions using a SLM is disclosed in U.S. Pat. No. 6,521,117 by Kocherginsky et al. In this patent, the membrane was impregnated with an organic carrier such as a β-diketone derivative in kerosene. The feed solution containing copper ions had a pH of from about 5.5 to 8.0 and the strip solution was an acidic solution.

Among the reasons why this SLM-based process for the separation of metal ions has not gained widespread acceptance on a commercial scale are: (i) a relatively low rate of mass transfer through the SLM, i.e., through the organic liquid; (ii) a relatively low stability of the SLM, where the carrier and the organic liquid may be washed out from the pores over time; and (iii) the expense of the required porous hydrophobic membranes.

### SUMMARY

The foregoing methods and systems for the separation of metal ions from an aqueous feed have a number of drawbacks. Ion exchange resins are expensive and are not stable with continued use. Also, ion exchange resins have not been developed for many metals. Liquid-liquid extraction, e.g., solvent extraction, requires large volumes of reactants, e.g., of liquids for the extraction and subsequent reextraction of the metals, which requires an operator to maintain large inventories of the reactants. Both in the case of ion-exchange resins and liquid-liquid extraction active transport from large, diluted solutions to the smaller and more concentrated solutions is impossible. Known SLM processes are hindered by slow reaction rates, instability and fouling of the aqueous feed with the organic liquid.

It is an objective of the present disclosure to provide an improved process for the recovery of metals from aqueous solutions using membranes with extraction and reextraction.

It is another objective of the present disclosure to provide a process that facilitates a faster recovery of the metals from aqueous solutions as compared to prior SLM-based processes.

It is another objective of the present disclosure to provide a process for the recovery of metals from a solution where the membrane-based system is continuously regenerated and does not require frequent reimpregnation and regeneration of the membrane with an organic liquid phase.

In one embodiment, a method for the separation of metal ions from an aqueous feed is disclosed. The method includes the steps of contacting a first side of a first hydrophilic membrane support with an aqueous feed comprising the metal ions, and contacting a second side of the first hydrophilic membrane support with an organic liquid. At least a portion of the metal ions migrate from the aqueous feed through the first hydrophilic membrane support to the organic liquid to form a metal-bearing organic liquid.

In another embodiment, a method for the separation and recovery of metal ions from an aqueous feed containing the metal ions is disclosed. The method includes the steps of extracting, within a first membrane support module, metal ions from an aqueous feed with an organic liquid. The organic liquid comprising the extracted metal ions is transported to a second membrane support module where the metal ions from the organic liquid are reextracted from the organic liquid phase and into a strip solution.

In yet another embodiment, systems for the extraction of metal ions from an aqueous feed are disclosed. The systems include an extraction module, the extraction module comprising a plurality of first hydrophilic polymer hollow fiber membrane supports operatively disposed within the extraction module, the hollow fiber membrane supports comprising a lumen through which liquid may flow. The extraction module also includes a first inlet port and a first outlet port in fluid communication with the first inlet port along a first fluid pathway, wherein the first fluid pathway comprises the lumens of the first hollow fiber membrane support. A second inlet port and a second outlet port in fluid communication with the second inlet port along a second fluid pathway are provided, wherein the second fluid pathway traverses a shell side volume between the first hollow fiber membrane supports. The system also includes a reextraction module, the reextraction module including a plurality of second hydrophilic polymer hollow fiber membrane supports operatively disposed within the reextraction module, the second hollow fiber membrane supports comprising a lumen through which liquid may flow. The reextraction module also includes a third inlet port and a third outlet port in fluid communication with the third inlet port along a third fluid pathway, wherein the third fluid pathway comprises the lumens of the third hollow fiber membrane supports, and a fourth inlet port and a fourth outlet port in fluid communication with the fourth inlet port along a fourth fluid pathway, wherein the fourth fluid pathway traverses a shell side volume between the second hollow fiber membrane supports. A first fluid conduit operatively connects the first outlet port to the first inlet port, a second fluid conduit operatively connects the second outlet port to the fourth inlet port; and a third fluid conduit operatively connects the fourth outlet port to the second inlet port.

In yet another embodiment, a method for the separation of lithium metal ions from an aqueous feed is disclosed. The method includes the steps of contacting the first side of a first hydrophilic polymer membrane support with an aqueous feed comprising the lithium metal ions, and contacting a second side of the first hydrophilic membrane support with an organic liquid. At least a portion of the lithium metal ions migrate from the aqueous feed through the first hydrophilic membrane support to the organic liquid to form a lithium-bearing organic liquid.

These and other embodiments of the present disclosure will be apparent from the following description.

### DESCRIPTION OF THE DRAWINGS

FIGS. 1A and 1B schematically illustrate a porous supported liquid membrane according to the prior art.

FIGS. 2A to 2C schematically illustrate a substantially non-porous supported liquid membrane according to the present disclosure.

FIG. 3 schematically illustrates a system for the extraction and reextraction of metal ions according to the present disclosure.

FIG. 4 schematically illustrates a system for the extraction and reextraction of metal ions according to the present disclosure.

FIG. 5 illustrates the concentration of strontium in an aqueous feed over time when the aqueous feed is treated according to an exemplary method of the present disclosure.

FIG. 6 illustrates the flux of strontium from an aqueous feed to a stripping solution over time when an aqueous feed is treated according to an exemplary method of the present disclosure.

FIG. 7 illustrates a theoretical decrease of strontium concentration in an aqueous feed when treated using modules of increasing length according to an exemplary method of the present disclosure.

FIG. 8 illustrates the concentration of magnesium and calcium in a feed solution and in a strip solution as a function of time according to an exemplary method of the present disclosure.

FIG. 9 illustrates the log of the concentration of magnesium and calcium in a feed solution input to an extraction module as a function of time according to an exemplary method of the present disclosure.

FIG. 10 illustrates the log of the concentration of magnesium and calcium in a feed solution removed from an extraction module as a function of time according to an exemplary method of the present disclosure.

FIG. 11 illustrates the log of the concentration of magnesium and calcium in a strip solution as a function of time according to an exemplary method of the present disclosure.

FIG. 12 illustrates the concentration of magnesium and calcium in an organic liquid removed from an extraction module as a function of time according to an exemplary method of the present disclosure.

FIG. 13 illustrates the rate constants as a function of aqueous feed flow rate and flow direction for the extraction and reextraction of magnesium according to an exemplary method of the present disclosure.

FIG. 14 illustrates the rate constants as a function of liquid organic flow rate for the extraction of magnesium according to an exemplary method of the present disclosure.

FIG. 15 illustrates the rate constants as a function of liquid organic flow rate for the extraction of magnesium according to an exemplary method of the present disclosure.

FIG. 16 illustrates the lithium concentration as a function of time for an aqueous feed and a strip solution according to an exemplary embodiment of the present disclosure.

### DETAILED DESCRIPTION

The present disclosure is directed to methods and systems for the separation of metals (e.g., of metal ions) from an aqueous feed, e.g., from an aqueous solution containing the metal ions. The methods and systems disclosed herein may be applicable to the recovery of virtually any metal ion from an aqueous solution. The metals that may be recovered include but are not limited to: base metals such as copper, lead, cobalt, nickel, tin, aluminum, and zinc; rare earth metals such as lanthanum, cerium, praseodymium, neodymium, promethium, samarium, europium, gadolinium, terbium, dysprosium, holmium, erbium, thulium, ytterbium, and lutetium; actinide metals such as thorium and uranium; alkali metals such as lithium, sodium and cesium; and alkaline earth metals such as strontium and barium. Also included among the metals that can be recovered are radioactive metals (e.g., radionuclides) that occur naturally or are manmade. Among the radioactive metals that may be recovered using the processes and systems disclosed herein are strontium (e.g., strontium-90), cesium (e.g., cesium-137), uranium (e.g., uranium-235 and uranium-238), and the like. The methods disclosed herein may be characterized as implementing “coupled facilitated counter transport” for the separation of the metal ions from an aqueous feed containing the metal ions. The foregoing are non-limiting examples of metal ions that may be separated from aqueous feeds according to the present disclosure.

The source of the aqueous feed may be virtually any source, including natural or synthetic (e.g., manmade) sources. In one implementation, the aqueous feed is characterized as being a wastewater stream, e.g., sourced from industrial effluent. In another characterization, the aqueous feed is sourced (e.g., is extracted) from an evaporation pond such as an evaporation pond that contains lithium. In another characterization, the aqueous feed is sourced from sea water, e.g., for the desalination of the sea water. The foregoing are non-limiting examples of aqueous feeds that may be processed according to the present disclosure.

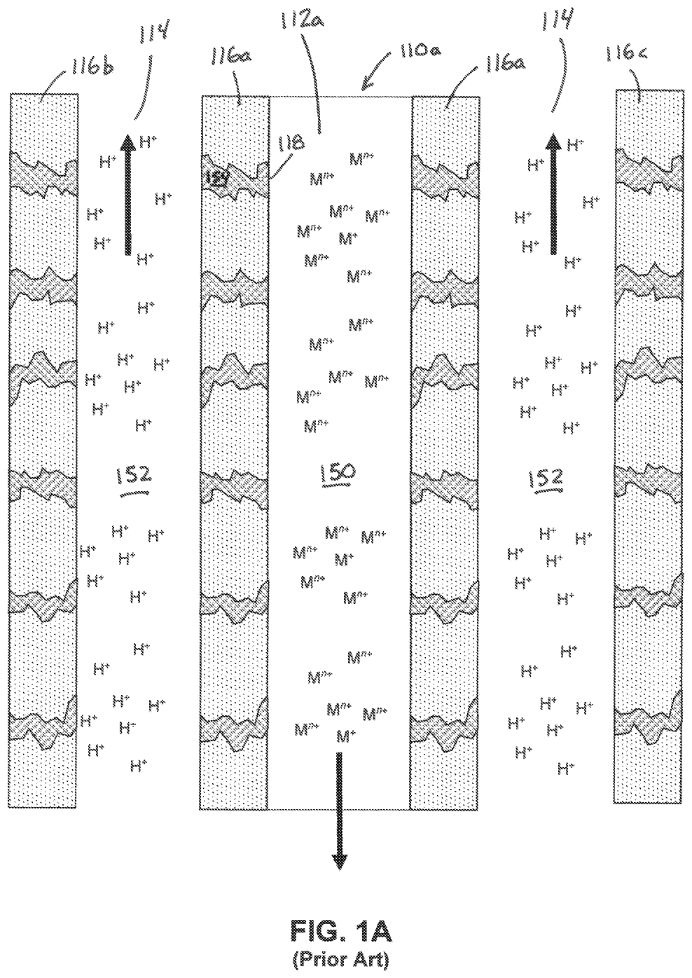

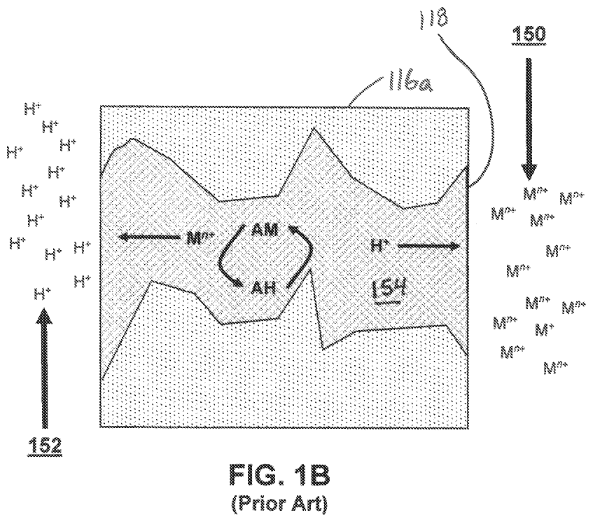

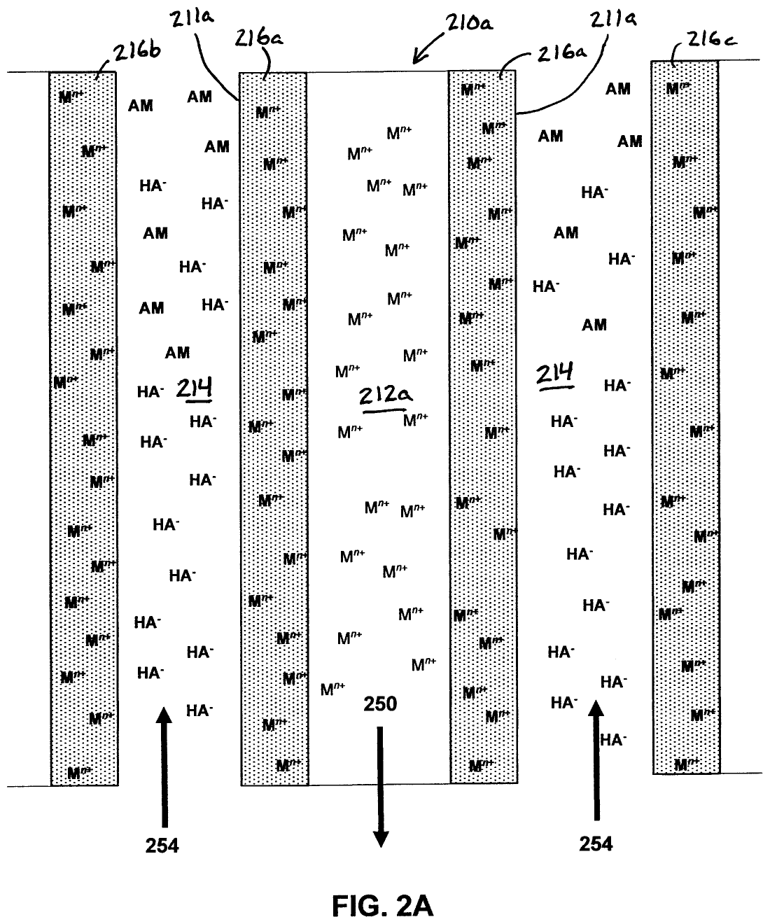

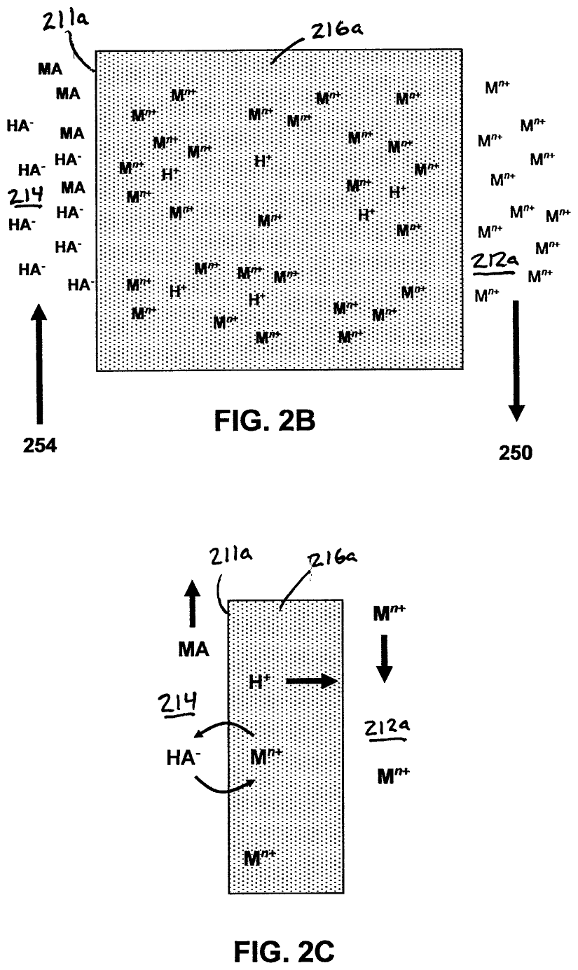

FIGS. 2A to 2C schematically illustrate an embodiment of such a coupled facilitated extraction according to the present disclosure. As with FIGS. 1A and 1B, FIGS. 2A-C illustrate the method being carried out using hollow fiber membrane supports. In this embodiment, an organic liquid 254 including an extractant HA⁻ is disposed on (e.g., flows along) one side of the shell side volume 214, e.g., between the hollow fiber 210a and the sidewalls 216b and 216c of adjacent hollow fibers. Simultaneously, an aqueous feed 250 containing metal ions Mⁿ⁺ flows through the lumen 212a of the hollow fiber 210a.

Total mass transfer resistance for transport through previously described SLMs with organic liquid in the pores is determined by total of resistances through stagnant aqueous layers and interfaces on both sides of the membrane, plus the mass transfer resistance for transport of the carrier through the organic liquid in the pores, membrane as illustrated in FIGS. 1A to 1B. The major component of total mass transfer resistance is this transport through the membrane, which is proportional to the membrane thickness (L) and inversely proportional to the carrier diffusion coefficient (D_{car}) in the organic liquid immobilized in the pores. As a result, the characteristic time

$$τ = \frac{{L}^{2}}{6 Dcar}$$

for a carrier molecule to move from one membrane side to the other may be of the order of one hour. Mass transfer resistance of both stagnant aqueous layers and interfaces usually is of the order 10% of total or less. According to the present disclosure, the dominant diffusion resistance of the organic liquid supported in the membrane is eliminated, enabling fast interface transport.

As compared to FIGS. 1A and 1B, according to the present disclosure the hollow fiber 210a is hydrophilic and is substantially non-porous, i.e., the sidewall 216a of the hollow fiber is substantially non-porous. In this regard, the hollow fiber 210a may be porous in the dry state; however, when the hydrophilic hollow fiber 210a comes into contact with the aqueous feed 250, the hollow fiber (e.g., the hollow fiber material) absorbs the aqueous feed and expands (e.g., swells), substantially closing off pores that existed in the dry state, e.g., the hollow fiber 210a is saturated with the aqueous feed. The organic liquid 254 in the shell side volume is unable to penetrate into the hydrophilic hollow fiber 210a, resulting in a single interface between the aqueous feed 250 and the organic liquid 254 at the fiber surface 211a. As a result, it is a relatively small metal ion and not a molecule of the larger organic extractant which diffuses in the membrane filled with an aqueous phase, which is also much less viscous than an organic liquid such as an oil. Both of these factors increase effective diffusion coefficient and the rate of transmembrane transport from aqueous to organic liquid, reducing the membrane mass transfer resistance.

Referring to FIG. 2C, the metal ions Mⁿ⁺ permeate the sidewall 216a with the aqueous feed. At the interface 211a with the shell side 214, the metal ions react with the carrier A⁻ in the organic liquid, exchanging with H⁺, i.e., migrating from an aqueous feed with a relatively low concentration of Mⁿ⁺. Final mass transfer resistance of this extraction step is essentially determined by only stagnant aqueous layers and one aqueous phase/organic liquid interface. The membrane still provides a large surface area of water/oil contact.

In one embodiment employing the foregoing concepts, a method for the separation of metal ions from an aqueous feed is disclosed. Broadly characterized, the method includes contacting a first side of a hydrophilic membrane support with an aqueous feed comprising the metal ions and contacting a second side of the hydrophilic membrane support with an organic liquid, wherein the metal ions are transported to the organic liquid through the first hydrophilic membrane support.

In one implementation, a first side of the hydrophilic membrane support (e.g., a first hydrophilic membrane support) is contacted with an aqueous feed comprising metal ions, where the hydrophilic membrane support absorbs a portion of the aqueous feed, e.g., where the membrane support swells by absorption of the aqueous feed. A second side of a hydrophilic membrane support is contacted with an organic liquid that contains at least a first extractant. The metal ions in the aqueous feed migrate into and through the hydrophilic membrane support and react with the extractant contained in the organic liquid to form an organic metal species. Thus, the concentration of the metal ions in the aqueous feed is reduced and the concentration of the metal ions in the organic liquid in the form of an organic metal species is increased.

As is discussed above, the use of a hydrophilic membrane support to contain the aqueous feed enables the formation of an interface between the aqueous feed supported by the membrane and the organic liquid that is in contact with one surface of the membrane support. The membrane support may have certain material and physical characteristics that facilitate its use in the processes and systems disclosed herein. In one embodiment, the membrane support is characterized as being polymeric, e.g., fabricated from a polymer. For example, the membrane support may be fabricated from a hydrophilic polymer, e.g., where the bulk of the membrane support comprises the hydrophilic polymer. The membrane support may also be fabricated from a material that is not hydrophilic, but that is coated with a second material that renders the membrane support hydrophilic. See, for example, U.S. Pat. No. 5,203,997 by Koyama et al. which is incorporated herein by reference in its entirety. Further, the membrane support may be fabricated from a blend of two or more polymers, e.g., where one of the polymers is hydrophobic and the other polymer is hydrophilic, i.e., having hydrophilic functional polymer groups.

In one characterization, the membrane support is fabricated substantially entirely from a hydrophilic polymer, i.e., the bulk of the membrane support is fabricated from the hydrophilic polymer. In this manner, the aqueous solution may be absorbed into the bulk of the membrane support, causing the membrane support to swell. However, the hydrophilic polymer should be selected so that it does not substantially dissolve into the aqueous feed solution, e.g., where the polymer is hydrophilic but substantially water insoluble. Examples of useful hydrophilic polymers include, but are not limited to, cellulose acetate (e.g., cellulose diacetate and cellulose triacetate), polysulfone (PS), polyether sulfone (PES), polyvinylidene fluoride (PVDF), poly(2-hydroxyethyl methacrylate), polyethylene glycol (PEG), and the like. One example of such a hollow fiber membrane is illustrated in U.S. Pat. No. 4,587,168 by Miyagi et al. which is incorporated herein by reference in its entirety

In one example, the membrane support may be characterized as being porous in the dry state, e.g., having pores of from about one nm to about 25 nm in diameter and a total porosity of from about 20 vol. % to about 40 vol. %. However, as noted above, when the membrane support is contacted with the aqueous feed, the membrane support may swell due to the absorption of water, e.g., the absorption of the aqueous feed. As a result of this swelling, substantially all of the porosity is eliminated. Thus, the membrane support in use may be characterized as being swollen and substantially non-porous. While not wishing to be bound by any theory, it is believed that the metal ions will transport through the substantially non-porous support by diffusion, e.g., in accordance with a well-known solution-diffusion model of mass transfer.

The membrane support may be of any configuration such as a flat sheet or a cylinder. In one embodiment, the membrane support is in the configuration of a plurality of individual hollow fiber membrane supports, e.g., hollow fibers that are operatively assembled into a membrane module, e.g., a cylindrical module. Each module may comprise hundreds to thousands of individual hollow fibers. An example of such a module is illustrated in U.S. Pat. No. 10,994,248 by Hayashi et al., which is incorporated herein by reference in its entirety.

The module may include an inlet (e.g., a first inlet) at a first end of the module and an outlet (e.g., a first outlet) at a second end of the module. The ends of the hollow fibers are potted such that a fluid passes through the lumen of the hollow fibers from the first inlet to the first outlet, e.g., along a fluid pathway from the first inlet to the first outlet. Another inlet (e.g., a second inlet) is in fluid communication with another outlet (e.g., a second outlet) where a fluid pathway passes through the shell-side volume of the module, i.e., around the hollow fibers and through the void space between the fibers. Accordingly, the aqueous feed may be passed through the lumen of the hollow fibers from the first inlet to the first outlet while the organic liquid is passed through the shell-side volume, or vice versa. Merely by way of example, the hydrophilic hollow fibers may have an inner diameter from about 100 μm to about 2000 μm and an outside diameter from about 130 μm to about 4000 μm. The fibers may have a wall thickness of at least about 13 μm and not greater than about 800 μm. The length of the fibers may be from about 200 mm up to about 2 meters.

Thus, one side of the membrane support is contacted with the aqueous feed containing the metal ions, e.g., as the aqueous feed flows through the lumen of the hollow fibers. The types of metal ions and the sources of the aqueous feed may be selected, for example, from those disclosed above. In one implementation, the pH of the aqueous feed is controlled (e.g., is adjusted as needed) to facilitate the transport of the metal ions to the interface with the organic liquid.

The opposite side of the membrane support (e.g., the shell-side volume of a hollow fiber module) is contacted with an organic liquid (e.g., an organic solvent) comprising one or more extractant, e.g., one or more organic extractant. For example, the organic liquid may flow from the second inlet to the second outlet along the fluid pathway through the shell-side volume of the hollow fiber membrane module. Due to the hydrophilic nature of the membrane support and the lack of substantial porosity due to swelling, the organic liquid will remain in contact with the membrane support surface, e.g., the outer surface of the hollow fibers, without substantially penetrating (e.g., infiltrating) the membrane support.

The extractant is a chemical compound that has an affinity for binding the metal ions from the aqueous feed. In one characterization, the extractant is a hydrophobic extractant. In another characterization, the extractant may be selected from a chelating agent, a carboxylic acid such as a fatty acid, an amine, an oxime (e.g., a phenolic oxime), derivatives of phosphinic acid, a phosphonic acid, or phosphoric acid, such as tributyl phosphate (TBP) or Bis (2-ethylhexyl)phosphoric acid (HDEHP), a crown acid, or their mixtures.

The organic liquid may be selected from any suitable organic liquid that is compatible with the desired function of the extractant. Examples of suitable organic liquids include, but are not limited to, hexane, benzene, kerosene, alcohols such as butanol or octanol, ketones such as octanone, liquid unsaturated fatty acids, and the like. In one example, to facilitate flow through a hollow fiber membrane support module, e.g., through the shell-side volume, the organic liquid may have a viscosity of at least about 0.6 centipoise and not greater than about 80 centipoises at room temperature.

As is disclosed above, the metal ions will transport (e.g., migrate or diffuse) through the hydrophilic membrane support to the interface with the organic liquid where the metal ion reacts with (e.g., binds with) the extractant to form an organic metal species with the extractant, e.g., an organic metal species. Simultaneously, the extractant gives up a proton (H⁺), which transports to the aqueous feed, to maintain a charge balance and causing the aqueous feed to become slightly more acidic as it flows along the membrane support. After this ion exchange at the interface the metal ion is extracted and is carried away with the organic liquid, e.g., driven by a pump that moves the organic liquid past the membrane support.

In one embodiment, solvent extraction may be used to strip (e.g., reextract) the metal ion from the organic metal species, e.g., in a second hollow fiber membrane module, so that the metal ions may be recovered. In one implementation, the organic metal species in the organic liquid is stripped of the metal ion due to a shift of ion exchange in more acidic media, e.g., the metal ion is reextracted from the organic metal species in a second hollow fiber membrane module. Other means of reextracting the metal ion from the organic metal species may be utilized.

Advantageously, the depleted organic liquid may be recirculated (e.g., recycled using a pump) back from the second module to the first module where the extraction step takes place. In one particular implementation, the reextraction step is carried out using a method similar to that disclosed above for the extraction step, e.g., using a hydrophilic membrane support such as hollow fibers to separate the organic liquid containing the organic metal species from a strip solution, e.g., from an acidic strip solution. In this configuration, the metal ions are reextracted from the organic metal species and migrate through the second hydrophilic membrane support, e.g., that is swollen with the aqueous strip solution, to the aqueous strip solution flowing on the opposite side of the membrane support in the second module. Thereafter, the metal ions may be separated from the concentrated strip solution, e.g., in the form of a metal salt of the acid used as the strip solution.

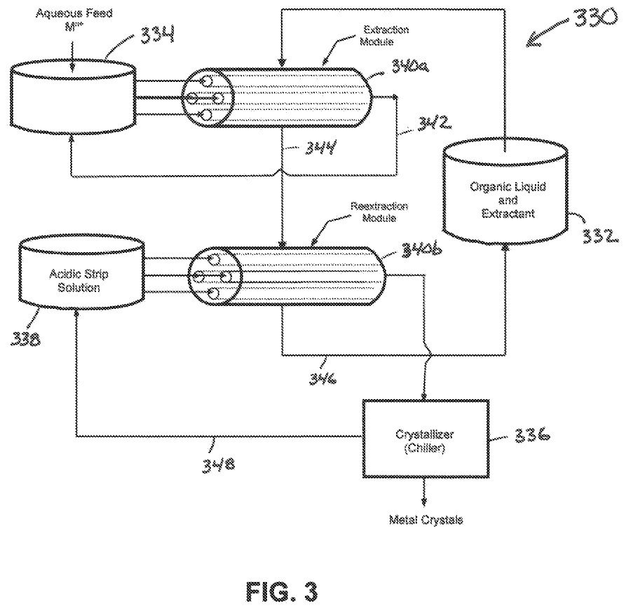

A system that is configured to implement the foregoing method of extraction and reextraction is illustrated in FIG. 3. The system includes a first hydrophilic polymer hollow fiber membrane support module 340a, e.g., an extraction module, substantially as disclosed above. Thus, the extraction module 340a includes a plurality of first hydrophilic polymer hollow fibers operatively disposed within the first module, where the hollow fibers include a lumen through which liquid may flow. The extraction module 340a also includes a first inlet port and a first outlet port that is in fluid communication with the first inlet port along a first fluid pathway. The first fluid pathway includes the lumens of the first hollow fiber membrane supports, i.e., so that an aqueous feed passes through the lumens as the feed flows from the first inlet port to the first outlet port. Similarly, extraction module 340a includes a second inlet port and a second outlet port that is in fluid communication with the second inlet port along a second fluid pathway. The second fluid pathway traverses the shell-side volume between the first hollow fiber membrane supports, e.g., so that an organic liquid flowing from the second inlet port to the second outlet port passes through the shell-side volume and does not flow through the lumens of the hollow fibers.

The system also includes a second hydrophilic polymer hollow fiber membrane support module 340b, e.g., a reextraction module. Similar to the extraction module 340a, the reextraction module 340b includes a plurality of (second) hydrophilic polymer hollow fibers operatively disposed within the reextraction module 340b. The hollow fibers include a lumen through which an aqueous strip solution may flow, i.e., from a (third) inlet port to a (third) outlet port in fluid communication with the inlet port along a (third) fluid pathway, where the fluid pathway includes the lumens of the hollow fiber membrane supports. A (fourth) inlet port and a (fourth) outlet port are in fluid communication along a fourth fluid pathway, wherein the fourth fluid pathway traverses the shell-side volume of reextraction module 340b.

A first fluid conduit 342 operatively connects the first outlet port of module 340a to the first inlet port of the same module 340a. Such an arrangement permits recycling of the aqueous feed through module 340a, e.g., using a pump, for continuous treatment of the aqueous feed. As illustrated in FIG. 3, the fluid conduit 342 includes a tank 334 configured for the storage of the aqueous feed and to enable control over the flow of the aqueous feed. Thus, instead of slow diffusion through an organic liquid in the pores of a supported liquid membrane, this system is driven by a pump that flows liquid from one membrane module to another and back, which may take less than 1 minute depending upon the size of the modules.

A second fluid conduit 344 operatively connects the second outlet port of the extraction module 340a to the fourth inlet port of the reextraction module 340b. Thus, the second fluid conduit 344 enables the organic liquid carrying the metal organic species to be pumped from the shell-side volume of the extraction module 340a to the shell-side volume of the reextraction module 340b. A third fluid conduit 346 operatively connects the fourth outlet port of module 340b to the second inlet port of module 340a, thus enabling the organic liquid containing the stripped organic extractant back to the extraction module 340a, e.g., in a closed loop. As illustrated in FIG. 3, the fluid conduit 346 includes a tank 332 configured for the storage of the organic liquid and to enable control over the flow of the organic liquid to the extraction module 340a. Further, this enables the organic liquid and/or extractant to be regenerated, e.g., continuously regenerated, even when the organic liquid and/or the extractant are slowly washed out into the aqueous solutions, thus solving a problem of supported liquid membrane instability over time.

The system illustrated in FIG. 3 also includes a fourth fluid conduit 348 operatively connecting the third outlet port of the reextraction module 340b to the third inlet port of the module 340b, enabling recirculation of the strip solution. As illustrated in FIG. 3, the fluid conduit includes an apparatus 336 (e.g., a chiller) to precipitate or otherwise separate metal crystals or metal compounds from the strip solution. Further, the fluid conduit 348 also includes a tank 338 for the storage of the strip solution and to control the flow of the strip solution through the reextraction module 340b.

The methods and systems disclosed herein may provide a number of advantages as compared to known metal separation methods and systems. The extraction and reextraction steps may be carried out at substantially ambient pressure, e.g., without requiring artificial pressure to be applied to the membrane modules. The extraction and reextraction steps may also be carried out in the absence of an electrical field, e.g., an artificially applied electrical field. The organic liquid may be recycled through the system, with only small amounts of fresh organic liquid being added to replace trace amounts that are lost during extraction and reextraction. The membrane supports may operate for long periods of time without becoming fouled and requiring frequent flushing or replacement. The hydrophilic membrane supports are low in cost as compared to other types of membrane supports.

### PROPHETIC EXAMPLES

### Example 1

Experiments with a supported liquid membrane (SLM) with long chain fatty acids as the extractant for the metal ions demonstrate that it could be used to actively pump potassium and sodium metal ions due to a pH difference across the membrane. Experiments with flat membranes of different thickness demonstrate that mass transfer resistance of unstirred stagnant aqueous layers is near 10% that of a 100 μm membrane. Using the methods disclosed herein, up to a 10x increase of transport rate can be expected.

### Example 2

It takes less than about 60 seconds to fill a hydrophilic hemodialysis membrane module with a small (e.g., pocket size) pump. The typical time for a fatty acid to diffuse through a membrane in the prior art SLM methods is greater than 1000 seconds. Again, using the methods disclosed herein up to a 10× increase of transport rate can be expected.

### Example 3

If hydrodynamic flow rates are not too high, fluxes of both the aqueous feed and the organic liquid are substantially laminar (e.g., not turbulent). The organic carrier migrates and reacts with metal ions (e.g., Li⁺, K⁺, Na⁺, etc.). This type of reactor is called a plug-flow reactor. Using some approximate models, it is estimated that with the use of a common hemodialysis module (Baxter Exeltra 150, a high-flux, single-use dialyzer with a membrane surface area of 1.5 m², containing ˜10,300 fibers, with a hollow fiber inner diameter of about 200 μm, a membrane thickness of about 15 μm, an effective length of about 21 cm, and a fiber bundle cross sectional area of about 3.24 cm²) in optimal conditions it is possible to transport almost 0.1 mole of metal ions per minute, i.e., for Li⁺ about 0.7 g/min. This means 10⁻⁸ mol/cm²/sec, i.e., about 10 times better than what is known for supported liquid membranes treating Na⁺ and K⁺ (see N. M. Kocherginsky, Facilitated transport of alkali metal cations through supported liquid membranes with fatty acids,” in Chemical separations with liquid membranes, Ed. R. A. Bartsch and J. D. Way, ACS, Washington, 1996, Chapter 5, p. 75-88).

### Example 4

In this example, strontium is extracted and reextracted using a two-module system, i.e., an extraction module and a reextraction module. Each module is an EXELTRA 150 dialyzer module (Baxter Scientific, Deerfield, Ill., USA) incorporating hollow fibers fabricated from cellulose triacetate and having a surface area of about 1.5 m² and a length of about 22 cm.

A 500 ml solution of 34% D2EHPA (Di-(2-ethylhexyl) phosphoric acid) extractant in mineral spirits is prepared. An alkaline aqueous feed solution is prepared by making a 1 L solution of 5 mM SrCl₂ in de-ionized water and adjusting to about pH 10 by gradually adding 1M sodium hydroxide. An aqueous acidic stripping solution is prepared by diluting hydrochloric acid in de-ionized water to form 500 ml of 1M HCl.

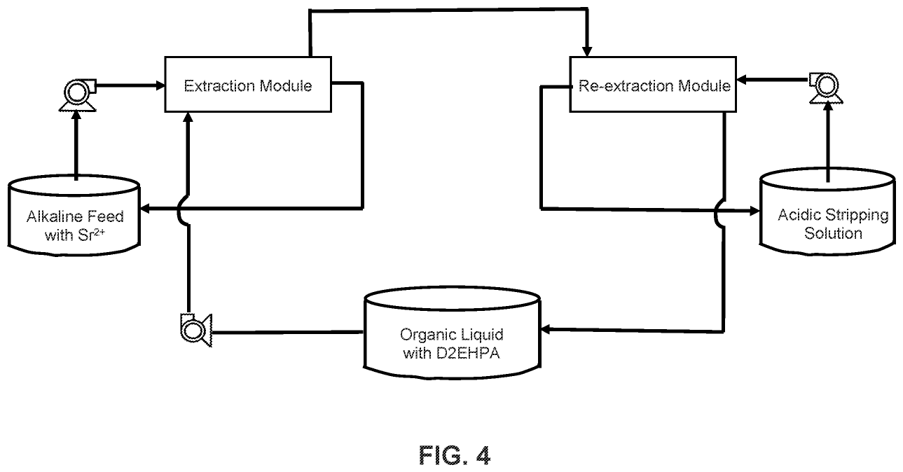

A schematic view of the system is illustrated in FIG. 4. The organic liquid containing the extractant is recirculated through both modules on the outer (shell) side of the hollow fibers. Aqueous solutions are contained in the hollow fibers of each module, with the alkaline feed solution containing Sr²⁺ in the extraction module and the acidic stripping solution in the reextraction module. Both solutions are recirculated. The aqueous solutions and the organic liquid have the same flow direction through the two modules, i.e., co-current flow.

The organic liquid flow rate is adjusted to 500 ml/min so that the transport of the organic liquid from one module to the other takes less than one minute. The flow rate of the aqueous feed and the stripping solutions are adjusted to 125 ml/min. Samples of the aqueous feed and the stripping solution are taken prior to entering the extractant module at times t=1, 5, 10, 20, 60, and 240 minutes for the alkaline feed and the acidic strip solution. Additional samples are collected at t=10 and 240 minutes for the alkaline feed and the acidic strip solution after the extraction module and prior to entering the reextraction module.

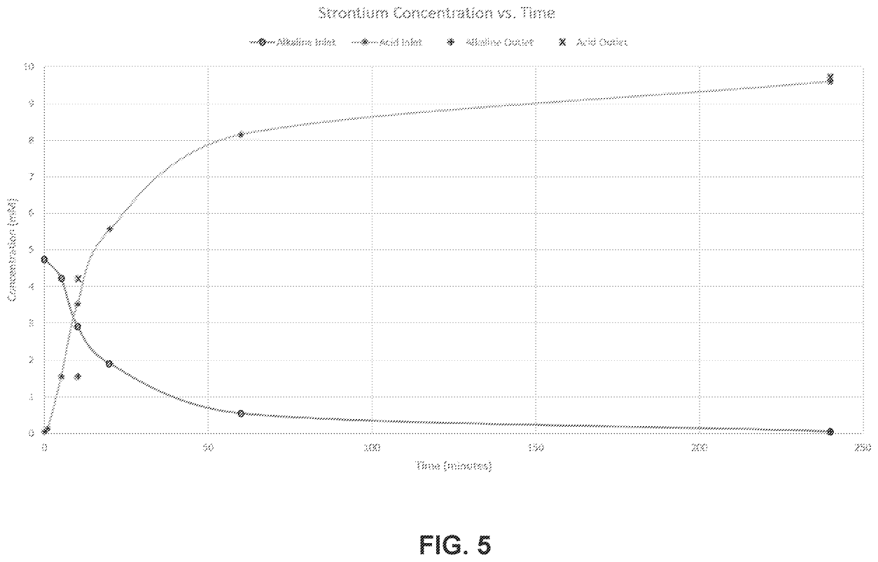

FIG. 5 illustrates the concentration of strontium in the aqueous feed and in the stripping solution over time. The alkaline inlet data represents the concentration of strontium entering the extraction module while the alkaline outlet data represents the concentration of strontium in the aqueous feed leaving the extraction module. Similarly, the acid inlet data represents the concentration of strontium in the stripping solution entering the reextraction module, while the acid outlet data represents the concentration of strontium in the stripping solution leaving the reextraction module. As illustrated in FIG. 5, within 120 minutes 90% of the strontium in the alkaline aqueous feed is transferred to the stripping solution.

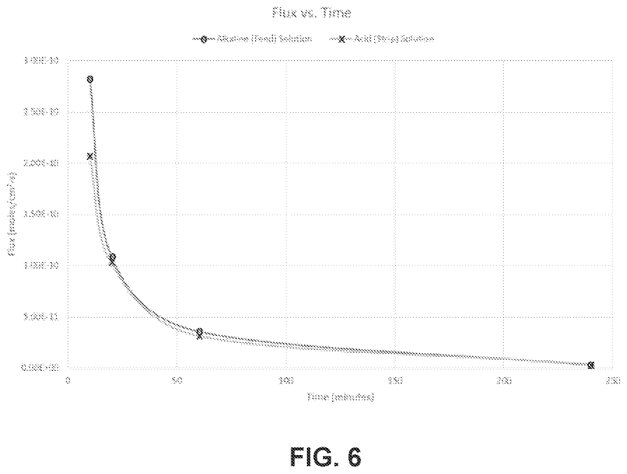

FIG. 6 illustates the flux of strontium from aqueous feed (o) and to the stripping solution (x) as a function of time. Extraction flux in the extraction module is calculated based on the concentrations of strontium in the alkaline inlet, while the reextraction flux in the reextraction module is calculated based on the concentrations of strontium in the acid inlet.

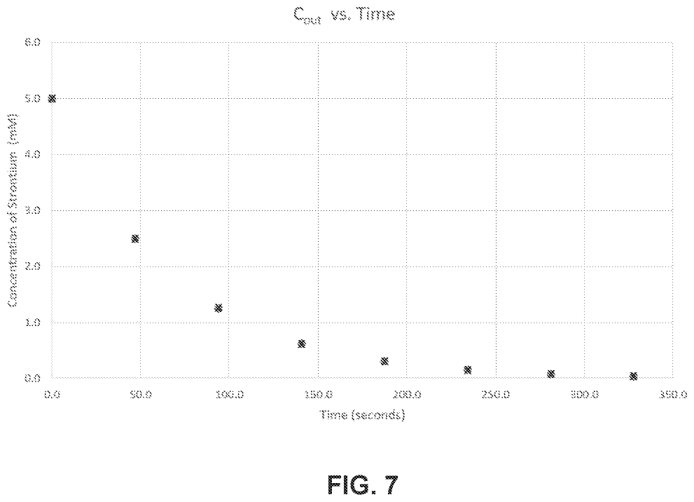

Sr removal is described by first order reaction kinetics. Based on half life time, which is aproximately time for the feed to move from the inlet to the outlet of the extraction module, FIG. 7 illustrates the theoretical decrease of strontium concentration in an aqueous feed after one pass through an extraction module having a length equal to a single experimental module described above (length=22 cm), two lengths (˜44 cm), etc. The x-axis represents the time, i.e., length of the theoretical module divided by the linear velocity of strontium solution in the module. By utilizing a single module having a length of 7× (i.e., about 1.5 meters), a 128× (2⁷) decrease of Sr concentration may be achieved, i.e., a near-zero strontium concentration at the outlet of the single module. This is important for the purification of water by removal of radioactive Sr impurities in atomic power plants.

The following reversible chemical equations are involved in the extraction process of the foregoing system, where “A” represents D2EHPA:

### Alkaline Feed to Organic Liquid

SrCl₂(aq1)+2HA(org)→SrA₂(org)+2H⁺(aq1)+2Cl⁻(aq1)

### Organic Liquid

2HA(org)+Sr²⁺(org)→2H⁺(org)+SrA₂(org)

### Organic Liquid to Acidic Stripping Solution

2HCl(aq2)+SrA₂(org)→SrCl₂(aq2)+2HA(org)

The alkaline conditions (pH=10) of the aqueous feed drive the transfer of protons (W) from the organic liquid into the aqueous feed. These protons are exchanged with strontium ions in the feed. Additionally, the acidic conditions (pH=0) in the strippin solution direct the transfer of protons from the stripping solution into the organic phase, releasing Sr²⁺. This makes the forward reaction shown above more favorable than the reverse.

### Example 5

### Removal of Calcium and Magnesium from an Aqueous Solution

An aqueous feed solution containing calcium and magnesium is obtained from the Saar del Hombre Muerto salt lake in Argentina. The aqueous feed solution comprises about 0.05M magnesium (Mg²⁺) and about 0.05M calcium (Ca²⁺).

Two identical hollow fiber membrane modules are configured in series, a first extraction module for the extraction of metals from the aqueous feed solution into an organic liquid, and a second reextraction module for reextraction of metals from the organic liquid into an acidic strip solution. The total surface area of the membrane in each module is about 1.5 m², the membrane length is about 22 cm, and the membrane module diameter is about 5 cm. The membranes are fabricated from cellulose triacetate, a hydrophilic polymer.

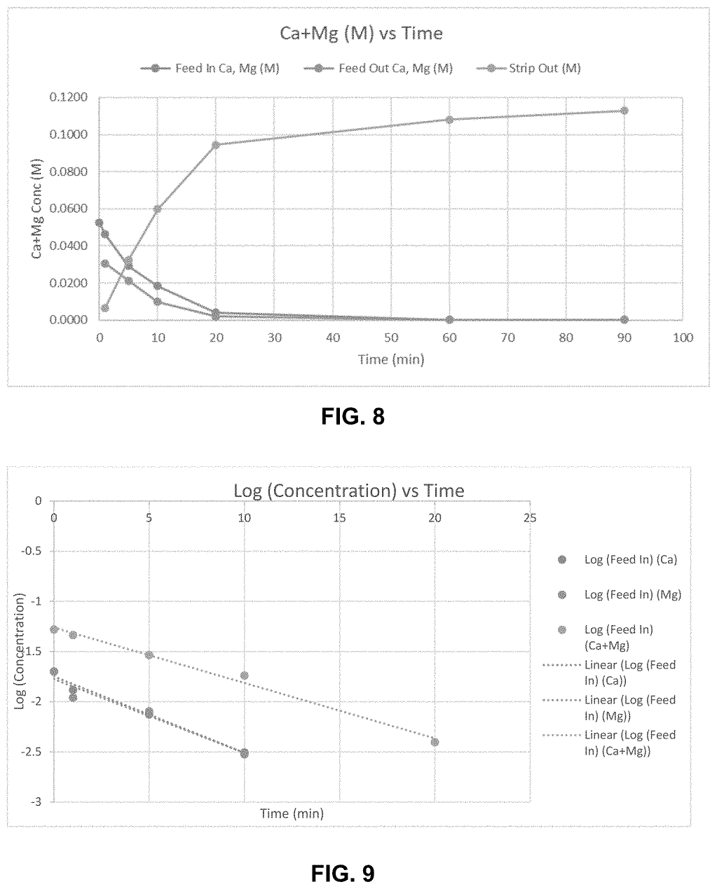

About 1 liter of the aqueous solution at a pH of about 7.5 is pumped through the hollow fibers of the extraction module at a flow rate of about 250 ml/min. Simultaneously, about 0.5 liter of an organic liquid comprising about 1M Di-(2-ethylhexyl) phosphoric acid (D2EHPA) in kerosene is pumped through the shell side of the hollow fibers at a rate of about 132 ml/min to extract metal ions from the aqueous feed solution to the organic liquid. The organic liquid is then pumped to the shell side of the reextraction module where about 0.5 liter of a strip solution comprising about 1M HCI (pH−0.2) is pumped through the hollow fiber membrane in the reextraction module at a flow rate of about 250 ml/min. Each liquid is pumped to the membrane modules at essentially ambient pressure and each liquid is circulated within its closed loop for about 90 minutes. As each liquid is circulated, samples are obtained at regular time intervals from the aqueous feed entering the extraction module, from the aqueous feed exiting the extraction module and from the acidic strip solution exiting the reextraction module. Calcium and magnesium concentrations in these samples are measured using an ion-selective electrode. The results are illustrated in FIG. 8.

Similar to the example with Sr²⁺, as illustrated in FIG. 8, the concentration of calcium and magnesium in the solution exiting the extraction module decreases by about 50% after one pass through the extraction module. Further, FIG. 8 illustrates that the concentration in the aqueous feed solution decreases from an initial concentration of about 0.05M each to essentially zero within about 60 minutes. The calcium and magnesium are transported to the acidic strip solution, where the final concentration of calcium and magnesium in the acidic strip solution is about 0.11M, i.e., more than in the initial feed solutions, due to active transport to the smaller volume of the strip solution.

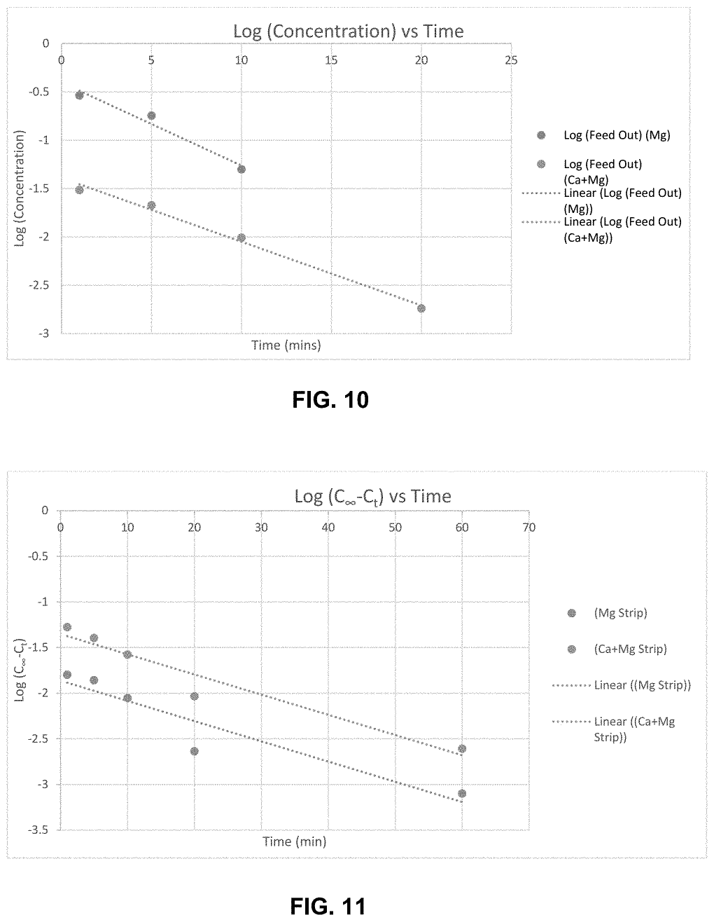

FIGS. 9 and 10 illustrate log plots of the concentration of calcium and magnesium in the aqueous feed solution entering the extraction module (FIG. 9) and exiting the extraction module (FIG. 10) as function of time. The log functions produce a substantially straight line in each plot, which again indicates that the extraction of calcium and magnesium follows first order kinetics. FIGS. 9 and 10 also illustrate that the rate constants (i.e., the slope) for calcium and magnesium individually and for a calcium and magnesium mixture are approximately the same. Based on the product of the slope and concentration it is possible to calculate the total flux in the system at any moment. It is found that the flux per unit area is at least about 10 times better than known supported liquid membrane systems.

FIG. 11 illustrates a log plot of (C_{∞}—Cₜ) vs time for the acidic strip solution, where C_{∞} is final equilibrium strip solution concentration. The log plot of (C_{∞}—Cₜ) vs time also produces a substantially straight line, which demonstrates that the reextraction of Mg and both metals together (Ca+Mg) from the organic liquid to the acidic strip solution also follow first order kinetics.

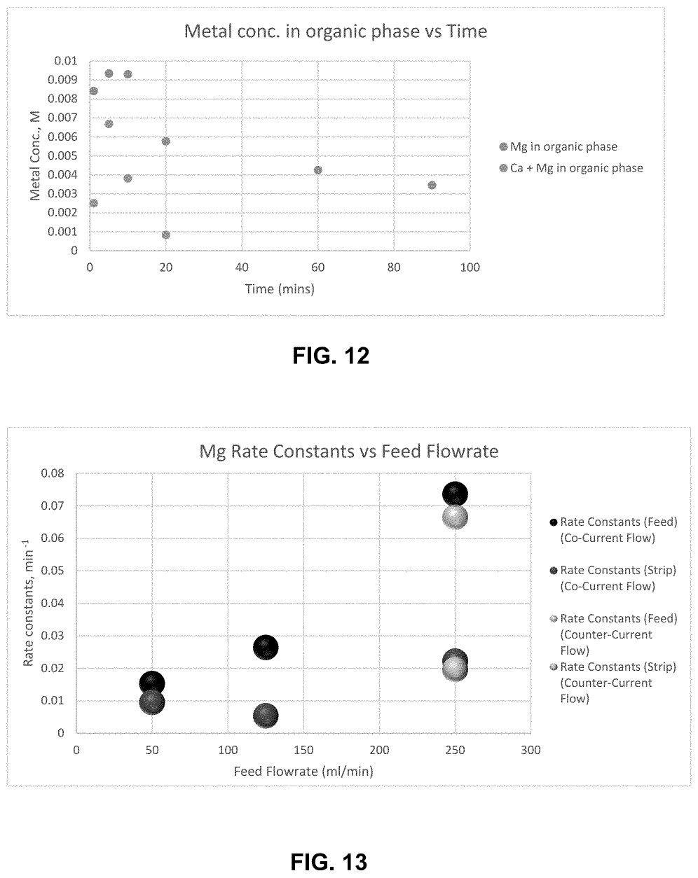

Based on mass balance, the concentration of metals in the organic liquid may be calculated. As illustrated in FIG. 12, metals are accumulated in the organic liquid and reach a steady state maximum at about 5 minutes. After about 5 minutes, the concentration of metals begins to decrease due to reextraction into the acidic strip solution in the reextraction module. FIG. 12 also illustrates that the affinity of the organic liquid, i.e., the D2EHPA, is higher for magnesium than for calcium. FIG. 12 also illustrates that the majority of the D2EHPA in the organic liquid is not bound to a metal, which demonstrates that the extractant is not saturated and explains the first order kinetics.

### Example 6

### Dependence of the Rate Constant on the Liquid Flow Rates

### A. Aqueous Feed Solution

This example illustrates the effect of the flow rate of the aqueous feed solution on the rate constant, as well as the effect of counter-current flow vs co-current flow of the aqueous feed and the organic liquid.

Two identical hollow fiber membrane modules are configured in series, a first extraction module for the extraction of metals from the aqueous feed solution into an organic liquid, and a second reextraction module for reextraction of metals from the organic liquid into an acidic strip solution. The total surface area of the membrane in each module is about 1.5 m², the membrane length is about 22 cm, and the membrane diameter is about 5 cm. The membranes are fabricated from cellulose triacetate, a hydrophilic polymer.

About 1 liter of an aqueous feed solution comprising about 0.02 M Mg²⁺ at about pH 9 is prepared. This aqueous feed solution is pumped through the hollow fibers of the extraction module while about 0.5 liter of an organic liquid comprising about 1M D2EHPA in kerosene is pumped through the shell side of the extraction module. After being pumped through the shell side of the module, the organic liquid is pumped through the shell side of the reextraction module while about 0.5 liter of an acidic 1M HCl stripping solution at about pH−0.2 is pumped through the hollow fibers in the reextraction module. For this example, the flow rate of the acidic stripping solution is maintained at about 250 ml/min and the flow rate of the organic liquid is maintained at about 132 ml/min, while the flow rate and the flow direction of the aqueous feed is changed.

FIG. 13 illustrates the results of changing the flow rate and direction of the aqueous feed solution. FIG. 13 illustrates that the rate constant for extraction of magnesium from the aqueous feed solution increases with an increase in the feed flow rate, e.g., from a rate constant of about 0.015 at 50 ml/min to about 0.074 at about 250 ml/min. Further, the data indicates that the flow direction relative to the organic liquid in the extraction module has little effect on the rate constant, showing that the rate constant in co-current flow is about 0.074 at 250 ml/min while the rate constant in counter-current flow is about 0.067 at a flow rate of 250 ml/min. However, increasing the feed flow rate of the aqueous feed solution does not have a major effect on the rate constant of reextraction into the acidic strip solution. As seen in FIG. 13, the rate constant for reextraction is about 0.095 at an aqueous feed rate of about 50 ml/min and the rate constant for reextraction is about 0.022 at an aqueous feed rate of about 250 ml/min. The mass transfer rate also increases with an increase of the flow rate (cm/sec) of the feed solution. This and the fact that the first order rate constants are the same or very similar for different metals indicates that the chemical extraction step and the transport through the impregnated membrane are not rate-limiting steps. The process is much faster than known processes and the extraction rate is determined by the metal ion diffusion rate in the unstirred aqueous layers near the membrane surface.

The foregoing supports the conclusion that the methods of the present disclosure are fundamentally different than prior methods implementing membrane supports, as the efficiency of the present methods depends upon the hydrodynamics, e.g., the flow rates of the liquids, and not on the properties of the membrane support. According to the methods of the present disclosure, the membrane support is swollen by water, which has much lower viscosity than an organic liquid such as an oil. In addition, the species penetrating the membrane support are metal ions, which are much smaller than a species formed by an organic extractant and a metal. As a result, the diffusion coefficient in the membrane and membrane permeability are much higher and the membrane is not a rate limiting step.

Lamellar flow in the hollow fiber is characterized by the existence of a stagnant unstirred aqueous layer in the fiber. Taking the thickness of this layer to be 0.01 cm (approximately the fiber radius) and diffusion coefficients of metal ions in water near 5×10⁻⁶ cm²/s, the permeability of this layer, i.e., the average flux per unit area divided by concentration, is 5×10⁻⁴ cm/s, i.e., close to the experimental mass transfer rate constant both for Ca²⁺ and Mg²⁺ when the feed flow rate was 250 ml/min.

### B. Organic Liquid

Two identical hollow fiber membrane modules are configured in series as described in Example 5 above. About 1 liter of an aqueous feed solution comprising about 0.02 M Mg²⁺ at about pH 9 is prepared. This aqueous feed solution is pumped through the hollow fibers of the extraction module while about 0.5 liter of an organic liquid comprising about 1M D2EHPA in kerosene is pumped through the shell side of the extraction module. After being pumped through the shell side of the module, the organic liquid is pumped through the shell side of the reextraction module while about 0.5 liter of an acidic 1M HCl stripping solution at about pH 0 is pumped through the hollow fibers in the reextraction module. For this example, the flow rate of the aqueous feed solution and the flow rate of the acidic stripping solution are both maintained at about 250 ml/min. Only the flow rate of the organic liquid is changed.

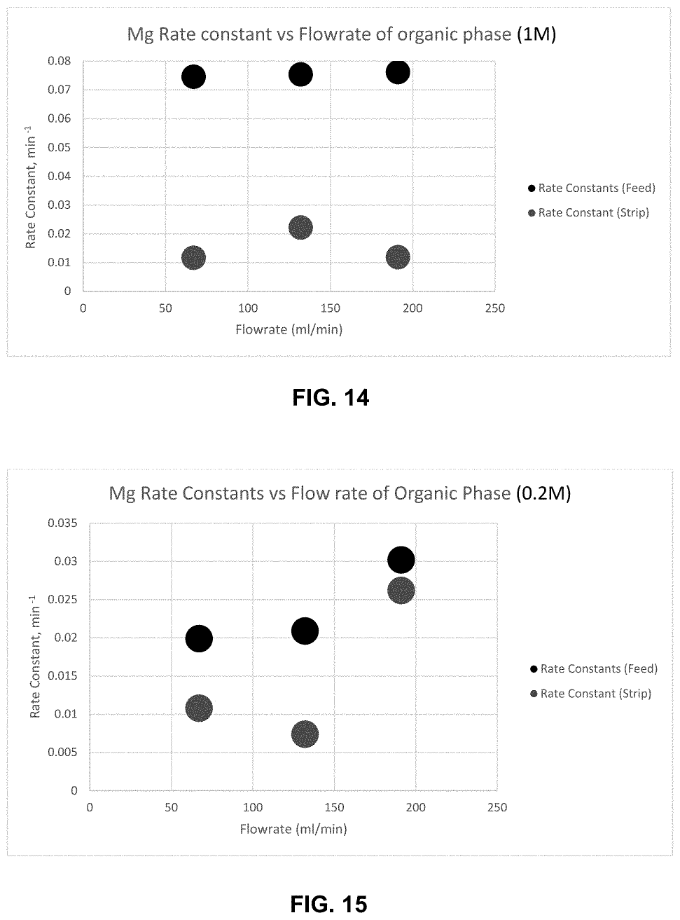

FIG. 14 illustrates the results of changing the flow rate and direction of the organic liquid. FIG. 14 illustrates that the rate constant for extracting the metal from the aqueous feed solution into the organic liquid is higher than the rate constant for stripping the metal from the organic liquid into the strip solution at all organic liquid flow rates. The rate constant does not appreciably change for either the extraction or reextraction steps at different organic liquid flow rates, demonstrating that the organic liquid flow rate is not rate limiting in these conditions.

### Example 7

### Lower Extractant Concentrations

This example looks at the effect of a lower extractant concentration in the organic liquid at different organic liquid flow rates. Two identical hollow fiber membrane modules are configured in series as described in Example 5 above. About 1 liter of an aqueous feed solution comprising about 0.02 M Mg²⁺ at about pH 9 is prepared. This aqueous feed solution is pumped through the hollow fibers of the extraction module while about 0.5 liter of an organic liquid comprising about 0.2 M D2EHPA in kerosene is pumped through the shell side of the extraction module. Thus, as compared to the previous example, the concentration of extractant in the kerosene is reduced from about 1 M to about 0.2 M.

After being pumped through the shell side of the module, the organic liquid is pumped through the shell side of the reextraction module while about 0.5 liter of an acidic 1M HCl stripping solution at about pH 0 is pumped through the hollow fibers in the reextraction module. For this example, the flow rate of the aqueous feed solution and the flow rate of the acidic stripping solution are both maintained at about 250 ml/min. Only the flow rate of the organic liquid is changed.

FIG. 15 illustrates the results of changing the flow rate of the organic liquid. Using an extractant concentration of 0.2 M D2EHPA, the rate constants for both extraction from the aqueous feed solution and reextraction into the acidic strip solution both depend upon the flow rate of the organic liquid. At lower concentration of the extractant, the transport resistance of the chemical and transport steps with participation of the extractant is higher and this transport resistance plays an essential role.

### Example 8

### Extraction of Lithium

This example demonstrates the extraction and reextraction of monovalent lithium ions from an aqueous feed solution according to the present disclosure.

Two identical hollow fiber membrane modules are configured in series, a first extraction module for the extraction of metals from the aqueous feed solution into an organic liquid, and a second reextraction module for reextraction of metals from the organic liquid into an acidic strip solution substantially as described in Example 5. About 0.5 liter of an aqueous feed solution comprising about 0.5 M lithium at pH of about 11.0 is prepared. This aqueous feed solution is pumped through the hollow fibers of the extraction module, while about 0.5 liter of an organic liquid comprising about 40% of a phosphorus-based extractant (CYANEX 936P, Solvay S.A., Brussels, Belgium) in kerosene is pumped through the shell side of the extraction module. After pre-equilibration for 300 min the organic liquid is pumped through the shell side of the reextraction module while about 0.5 liter of an acidic 0.1 M HCl strip solution at about pH 1 is pumped through the hollow fibers in the reextraction module. Once the lithium in the feed solution is depleted at about 620 minutes, 0.5 liter of a fresh aqueous feed solution is supplied to the system to continue the extraction and reextraction of lithium into the strip solution.

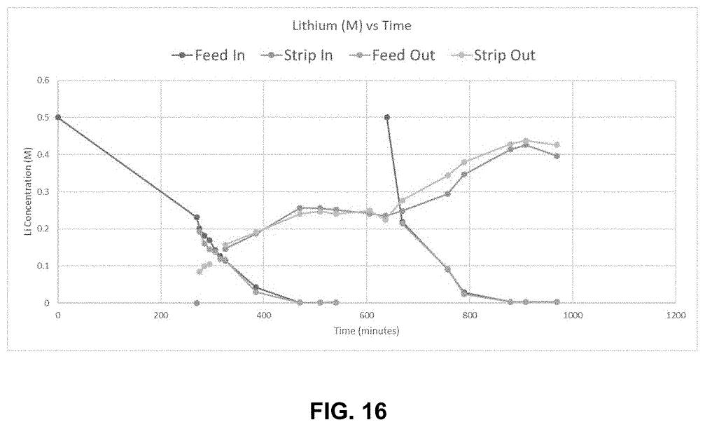

The shell side flow rate of the organic liquid is about 200 ml/min and the flow rates of the aqueous feed solution and the acidic strip solution are maintained at about 100 ml/min. FIG. 16 illustrates that the lithium in the aqueous feed solution is reduced to about zero in less than 600 minutes. When the fresh aqueous feed is supplied to the system at about 620 minutes, this fresh aqueous feed solution reaches a concentration of about zero in less than about 300 minutes.

While various embodiments of methods and apparatus for the separation of metal ions from an aqueous feed have been described in detail, it is apparent that modifications and adaptations of those embodiments will occur to those skilled in the art. However, is to be expressly understood that such modifications and adaptations are within the spirit and scope of the present invention.

1. A method for the separation of metal ions from an aqueous feed, comprising the steps of:
contacting a first side of a first hydrophilic membrane support with an aqueous feed comprising the metal ions; and
contacting a second side of the first hydrophilic membrane support with an organic liquid;
wherein at least a portion of the metal ions migrate from the aqueous feed through the first hydrophilic membrane support to the organic liquid to form a metal-bearing organic liquid.

2. The method recited in claim 1, wherein the first hydrophilic membrane support is a hydrophilic polymer membrane support.

3. The method recited in claim 2, wherein a bulk of the first hydrophilic membrane support is coated with a hydrophilic polymer.

4. The method recited in claim 2, wherein a bulk of the first hydrophilic membrane support is fabricated from a hydrophilic polymer.

5. The method recited in claim 3, wherein the hydrophilic polymer is selected from the group consisting of cellulose acetate, polysulfone, polyether sulfone, polyvinylidene fluoride, poly(2-hydroxyethyl methacrylate) and polyethylene glycol (PEG).

6. The method recited in claim 2, wherein the first hydrophilic polymer membrane support comprises a plurality of hydrophilic polymer hollow fibers, each hollow fiber comprising a sidewall defining a lumen therethrough to facilitate the transport of a liquid through the length of the hollow fiber.

7. The method recited in claim 6, wherein the hollow fibers are operatively disposed in a hollow fiber membrane module.

8. The method recited in claim 7, wherein the hollow fiber membrane module comprises:
a lumen-side fluid inlet that is configured to direct the aqueous feed through the lumens of the hollow fibers; and
a lumen-side fluid outlet that is in fluid communication with the lumen-side fluid inlet to discharge the aqueous feed from the lumens of the hollow fibers.

9. The method recited in claim 8, wherein the hollow fiber membrane module comprises:
a shell-side fluid inlet that is configured to direct the organic liquid through the shell side of the hollow fiber membrane module; and
a shell-side fluid outlet that is in fluid communication with the shell-side fluid inlet to discharge the organic liquid from the shell side of the hollow fiber membrane module.

10-18. (canceled)

19. The method recited in claim 1, wherein the portion of metal ions that migrate through the first hydrophilic membrane support to the organic liquid comprise base metal ions.

20. The method recited in claim 19, wherein the base metal ions are selected from the group consisting of copper, lead, cobalt, nickel, tin, aluminum, and zinc metal ions.

21. The method recited in claim 1, wherein the portion of metal ions that migrate through the first hydrophilic membrane support to the organic liquid comprise rare earth metal ions.

22. The method recited in claim 1, wherein the portion of metal ions that migrate through the first hydrophilic membrane support to the organic liquid comprise actinide metal ions.

23. The method recited in claim1, wherein the portion of metal ions that migrate through the first hydrophilic membrane support to the organic liquid comprise alkali metal ions.

24. The method recited in claim 23, wherein the alkali metal ions that migrate through the first hydrophilic membrane support to the organic liquid comprise lithium metal ions.

25. The method recited in claim 1, wherein the portion of metal ions that migrate through the first hydrophilic membrane support to the organic liquid comprise radioactive metal ions.

26. The method recited in claim 6, wherein the step of contacting the first side of the first hydrophilic membrane support with an aqueous feed comprises conveying the aqueous feed through the lumens of the hydrophilic polymer hollow fibers.

27. The method recited in claim 9, wherein the step of contacting the second side of the first hydrophilic membrane support with the organic liquid comprises conveying the organic liquid through the shell-side of the hollow fiber membrane module.

28. The method recited in claim 1, wherein the organic liquid comprises an extractant.

29. The method recited in claim 28, wherein the extractant is dispersed in a carrier liquid.

30. The method recited in claim 29, wherein the carrier liquid is selected from the group consisting of hexane, benzene, kerosene, an alcohol, a ketone and liquid unsaturated fatty acids.

31. The method recited in claim 28, wherein the extractant is an organic extractant and wherein the portion of the metal ions that migrate to the organic liquid bind with the organic extractant to form an organic metal species.

32. The method recited in claim 31, wherein the organic extractant is selected from the group consisting of a fatty acid, oxyquinoline, an organic derivative of a phosphoric acid, an organic derivative of a phosphonic acid, a chelating agent and mixtures thereof.

33. The method recited in claim 1, wherein the steps of contacting the first side of a first hydrophilic membrane support with the aqueous feed and contacting the second side of the first hydrophilic membrane support with the organic liquid are carried out at substantially ambient pressure.

34. The method recited in claim 1, wherein the steps of contacting the first side of a first hydrophilic membrane support with the aqueous feed and contacting the second side of the first hydrophilic membrane support with the organic liquid are carried out in the absence of an applied electric field.

35. The method recited in claim 1, further comprising the step of re-extracting the metal ions from the metal-bearing organic liquid.

36. The method recited in claim 35, wherein the step of re-extracting the metal ions from the metal-bearing organic liquid comprises the steps of:
contacting a first side of a second hydrophilic membrane support with a strip solution; and
contacting a second side of the second hydrophilic membrane support with the metal-bearing organic liquid;
wherein at least a portion of the metal ions contained in the metal-bearing organic liquid migrate through the second hydrophilic membrane support to the strip solution to form a metal-bearing strip solution and a metal-depleted organic liquid.

31-91. (canceled)
